(19) United States
(12) Patent Application Publication
(10) Pub. No.: US 2012/0266123 A1
(43) Pub. Date: Oct. 18, 2012

(54) COHERENT ANALYSIS OF ASYMMETRIC AGING AND STATISTICAL PROCESS VARIATION IN ELECTRONIC CIRCUITS

(75) Inventors: Palkesh JAIN, Bangalore (IN); Vinod Menezes, Bangalore (IN); Francisco Cano, Sugar Land, TX (US)

(73) Assignee: Texas Instruments Incorporated, Dallas, TX (US)

(21) Appl. No.: 13/084,582

(22) Filed: Apr. 12, 2011

(51) Int. Cl. G06F 9/455

(52) U.S. Cl. 716/112

(57) ABSTRACT

Coherent analysis of asymmetric aging and statistical process variation. A method of designing a circuit includes preparing an initial netlist of components in the circuit. A plurality of components is selected from the initial netlist by a first statistical process. Further, a process variation netlist is prepared by replacing a plurality of initial operating parameters of the plurality of components with a plurality of process variation operating parameters. A plurality of high stress components is then identified in the process variation netlist and an aged netlist is prepared by replacing a set of operating parameters of the plurality of high stress components with a set of degraded operating parameters. The circuit is simulated using the aged netlist. The method also includes modifying the initial netlist according to a result of simulation and repeating the foregoing steps until a desired circuit performance is obtained.

### TECHNICAL FIELD

Embodiments of the disclosure relate to coherent analysis of asymmetric aging and statistical process variation in electronic circuits.

### BACKGROUND

In today's semiconductor fabrication facilities, integrated circuits (ICs) are more miniaturized to achieve enhanced performance and functions. Miniaturization of the ICs allows millions of transistors to be formed on a single substrate. The ICs are put through quality assurance and reliability testing. Any imperfections introduced during the manufacturing process of ICs would result in transistor-to-transistor performance variations known as process variations. For example, variability of transistor attributes (length, width, oxide thickness, doping concentration, etc) results in the process variations.

Apart from the process variations, electronics components are subject to degradation due to aging. A known mode of transistor degradation is negative biased temperature instability (NBTI) degradation that effects primarily P-channel metal-oxide-semiconductor (PMOS) transistors. The NBTI causes the threshold voltage Vₜ of the transistor to increase when the voltage at the gate is negative, resulting in aging of transistors. Such aging of transistors is generally asymmetric, that is, different transistors in a circuit age at different rates, as they are each subject to different patterns of excitations.

Existing techniques to solve the problems described above make use of conservative design margins and guard-bands, or degraded end-of-life (EOL) transistor models. One such existing technique for measuring transistor simulates the effects of process variations and transistor aging. However, the existing technique verifies process variations by setting all active transistors on the complex chip at a single performance point, such as a weak process variation point, a normal process variation point or a strong process variation point, and analyzes the circuit's behavior either at t=0 or t=EOL. In reality, the worst circuit behavior happens not necessarily when all the constituent components are at their weakest; instead the worst performance may manifest at some weak-normal-strong combination of components. Additionally, the existing technique is not applicable for quick and efficient simulation of complex and large circuits.

Furthermore, the existing techniques do not perform simultaneous analysis of statistical worst process variation point and asymmetric aging. In summary, merely testing a circuit at one of two time-points (t=0 or t=EoL) and at a few process corners (all transistors at strong, or all at weak or all at nominal) may leave problem areas in the design that tend to get worse with clock gating and static inputs.

### SUMMARY

An example of a method of designing a circuit includes preparing an initial netlist of components in the circuit. A plurality of components is selected from the initial netlist by a first statistical process. The method also includes preparing a process variation netlist by replacing a plurality of initial operating parameters of the plurality of components with a plurality of process variation operating parameters. A plurality of high stress components is identified in the process variation netlist. Further, the method includes preparing an aged netlist by replacing a set of operating parameters of the plurality of high stress components with a set of degraded operating parameters and simulating the circuit using the aged netlist. Further, the method also includes modifying the initial netlist according to a result of the simulating and repeating the foregoing steps until a desired circuit performance is obtained.

An example of a circuit system for designing a circuit includes a communication interface in electronic communication with one or more electronic circuits, a memory coupled to the communication interface for storing a plurality of instructions and a processor coupled to the communication interface and the memory. The processor is responsive to the plurality of instructions to prepare an initial netlist of components in the circuit. The processor is also responsive to the plurality of instructions to prepare a process variation netlist by using a statistical process to select a plurality of components from the initial netlist, and replace initial operating parameters of selected components with process variation operating parameters. Further, the processor is responsive to the plurality of instructions to identify any high stress components in the process variation netlist, prepare an aged netlist by replacing a set of operating parameters of the high stress components with a set of degraded operating parameters, simulate the circuit using the aged netlist and modify the initial netlist according to a result of the simulate and repeat the above operations until a desired circuit performance is obtained.

### BRIEF DESCRIPTION OF THE VIEWS OF DRAWINGS

In the accompanying figures, similar reference numerals may refer to identical or functionally similar elements. These reference numerals are used in the detailed description to illustrate various embodiments and to explain various aspects and advantages of the disclosure.

FIG. 1 is a flow diagram illustrating a method of designing a circuit, in accordance with an embodiment;

FIG. 2 is a flow diagram illustrating a fast and efficient asymmetric aging analysis on a circuit, in accordance with one embodiment;

FIG. 3 is a flow chart illustrating a obtaining of worst-case circuit performance for statistical process variation, in accordance with an embodiment;

FIG. 4 is a graphical representation illustrating a relation between a process variation point and a frequency of occurrence, in accordance with one embodiment;

FIG. 5 is a block diagram of a system for designing a circuit, in accordance with one embodiment;

FIG. 6 is a circuit representation illustrating the effect of process variation on an XOR network being fed by a first inverter and a second inverter; and

FIG. 7 is a circuit representation illustrating the effect of asymmetric aging on a circuit of two cascaded complementary metal-oxide-semiconductor (CMOS) inverters.

### DETAILED DESCRIPTION OF THE EMBODIMENTS

Various embodiments discussed in this disclosure relate to coherent analysis of asymmetric aging and statistical process variation.

Transistors in an integrated circuit (IC) age and subsequently suffer from failures or poor operations after a certain time period of operation. Different transistors in an IC age asymmetrically, that is, they age at different rates. The rate of aging of transistors depends on the operation history of ICs including the workloads, voltage levels, bit patterns, slews, duty cycles, and temperatures. By understanding the rate of aging and where a worst process variation point exists in the circuit, designers can determine whether design performance specifications could possibly be violated, and in turn, threaten the design reliability. In order to determine the quantitative impact of aging due to the worst process variation point and process variation, an accurate and reliable model is needed. The present disclosure describes such a model.

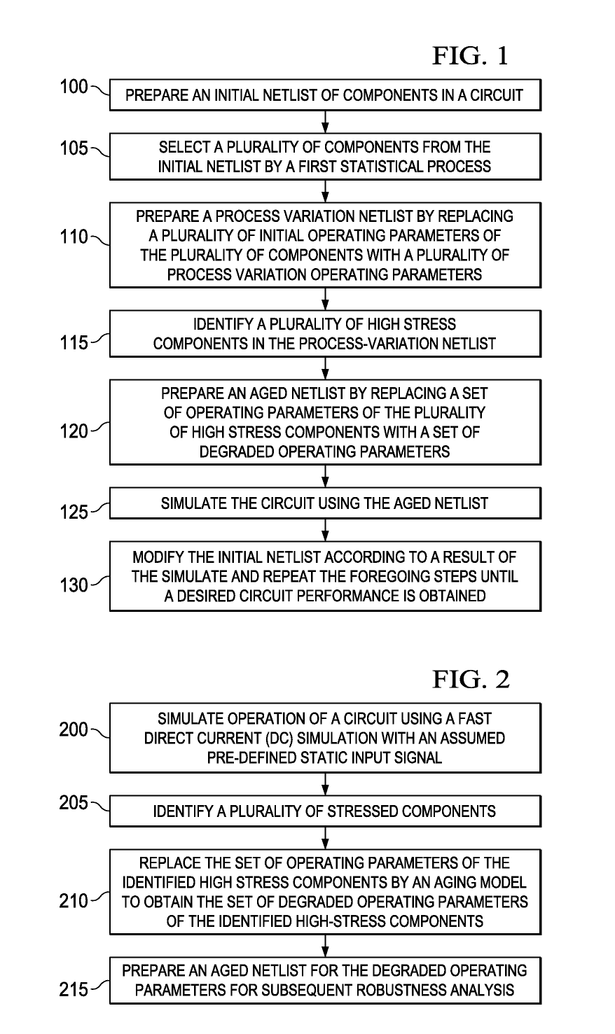

As in FIG. 1, a flow diagram illustrating a method of designing a circuit is shown.

At step 100, an initial netlist of components in the circuit is prepared. A netlist includes a plurality of components present in the circuit and the interconnections between the plurality of components. Examples of the plurality of components within the circuit include, but are not limited to, a transistor, a resistor, a capacitor, an inductor, a current or voltage source, a diode, a substrate layer, or an insulating film. The circuit may be complex and large in structure.

At step 105, a plurality of components is selected from the initial netlist by a first statistical process. The statistical process can include a random selection of components from the initial netlist. The statistical process can be based on a histogram statistical analysis and a distribution statistical analysis.

At step 110, a process variation netlist is prepared by replacing a plurality of initial operating parameters of the plurality of components with a plurality of process variation operating parameters. The plurality of process variation operating parameters is selected randomly. Examples of operating parameters can include, but are not limited to, a threshold voltage, a collector current, a peak collector current, a peak base current, a total power dissipation, a junction temperature, an ambient temperature, a collector base cut-off current, a drain-source current, a collector emitter saturation voltage, or a base emitter saturation voltage. The process variation operating parameters refer to the operating parameters whose values have been changed based on manufacturing imperfections. The replacing of the plurality of initial operating parameters of the plurality of components with random selection of the plurality of process variation operating parameters is based on a statistical process.

In one embodiment, the statistical process considers an electrical parameter associated with one or more circuit components on the IC. The one or more circuit components can be electrical devices. In practice, any circuit component on the IC that has an inherent electrical parameter having a process variation can be considered for the statistical process.

At step 115, the plurality of high stress components in the process variation netlist is identified.

The plurality of high stress components are identified by simulating operation of the circuit using a fast direct current (DC) simulation with an assumed pre-defined static input signal. The fast DC simulation analyzes a plurality of static operating points at each nonlinear node and port in the circuit. Examples of the static operating points include, but are not limited to, DC voltages and currents. Any stressed components in the ON state at the static operating points can be then identified for determining the plurality of high stress components.

Based on results of the fast DC simulation, the plurality of high stress components are identified. In one embodiment, any components that are predominantly in an ON state are identified as the high stress components. Here, the predominantly in an ON state can refer to the components that are in ON state for more than a pre-defined time. In a second embodiment, any components that are subjected to a voltage level that is within a predefined interval of a corresponding breakdown level are identified as the high stress components. In a third embodiment, any components that are predominantly in an ON state and carry a current having a value less than a predefined value are identified as the high stress components. In a fourth embodiment, any resistive components that carry an electrical current having a magnitude that exceeds a predefined magnitude are identified as the high stress components. The resistive components can be metal interconnects in the circuit, thereby metal segments that carry large amount of current in a first-pass are identified. The metal segments will degrade because of electromigration. In a fifth embodiment, any capacitive components that are subjected to a quantity of electric charge of sufficient magnitude to cause a dielectric breakdown are identified as the high stress components. In a sixth embodiment, any diodes that are biased to within a predefined level of a reverse breakdown voltage are identified as the high stress components. In a seventh embodiment, any components having insulating films that are subjected to a voltage of breakdown level are identified as the high stress components.

As a general example, a transistor that is frequently in ON state, especially if it conducts no current, would be more stressed than other transistors.

At step 120, an aged netlist is prepared by replacing a set of operating parameters of the plurality of high stress components with a set of degraded operating parameters.

The set of degraded operating parameters of the high-stress components are obtained by an aging model. As an example, simplest aging model relates the threshold voltage (Vₜ) of an aging P-channel metal-oxide-semiconductor (PMOS) transistor to a applied voltage, temperature and lifetime as [delta Vₜ=A*(exp beta V)(exp−Ea/kT)*t̂n], where V is the applied voltage, T is temperature, A is a fitting constant, beta is the voltage acceleration factor, Ea is the activation energy of the failure mechanism, k is the Boltzmann constant and ‘n’ is the power-law coefficient.

Finally, the aged netlist including the degraded operating parameters is prepared for subsequent robustness analysis.

At step 125, the circuit is simulated using the aged netlist. The circuit performance is obtained.

In an embodiment, an operation of the circuit with relevant operating parameters is simulated to obtain the circuit performance.

At step 130, the initial netlist is modified according to a result of simulation in step 125 and repeating steps 105 through 130 until a desired circuit performance is obtained

Using the simulation in step 125, a new process variation point is obtained. The process variation point is compared with a with a previous worst-case process variation point. The new process variation point includes the plurality of process variation operating parameters. If the new process variation point is worse than the previous worst-case process variation point then the plurality of process variation operating parameters are recorded as a set of worst-case operating parameters for the circuit. Based on the set of worst-case operating parameters, the circuit is modified and a desired circuit performance is obtained. Else if the new process variation point is not worse than the previous worst-case process variation point then the steps 105 through 130 are repeated till a worst-case process variation point is obtained. In an embodiment, the steps 105 through 130 can be repeated for a pre-defined number of times till the worst-case process variation point is obtained.

In some embodiment, the new process variation point is compared against a pre-defined worst process variation point. The steps 105 through 130 can be repeated until new process variation point is worse than the pre-defined worst process variation point. The plurality of process variation operating parameters corresponding to the new process variation point is recorded as a set of worst-case operating parameters. Correspondingly, the circuit is modified to obtain a desired circuit performance.

The desired circuit performance helps to verify that the circuit design is robust enough to withstand aging and provide performance which meets the system performance specification over design life under the worst process variation point. Thus the method enables simultaneous analysis of statistical worst process variation point as well as asymmetric aging analysis. Thus the desired circuit performance helps compute a yield of the circuit.

One of ordinary skill in the art will recognize that when a complementary metal-oxide semiconductor (CMOS) circuit is placed constantly under the same stress then the P-channel metal-oxide-semiconductor (PMOS) sections of the CMOS circuit ages at a different rate that a N-channel metal-oxide-semiconductor (NMOS) sections of the same circuit. It is also similarly true that different PMOS transistors of the same circuit age asymmetrically with reference to each other. Therefore, the present disclosure has determined that if the plurality of high stress components in the circuit can be accurately modeled, the changes in electrical characteristics observed during the stressing can be used to model IC aging more accurately.

The method is applicable for extremely light-weight automation that can be used for asymmetric aging analysis of complex and large circuits like memory compilers, SERDESs, or core cells. In general, typical simulation runtime required for the large and complex integrated circuit is also less.

FIG. 2 is a flow diagram illustrating a fast and efficient asymmetric aging analysis on a circuit.

At step 200, the circuit is simulated using a fast direct current (DC) simulation with an assumed pre-defined static input signal. The fast DC simulation analyzes the static operating points at each nonlinear node and port in the circuit. The static operating points include DC voltages and currents. In an embodiment, the static input signal is expected to be a most frequently occurring input when the circuit is deployed in a field.

At step 205, the plurality of stressed components are identified.

Using the fast DC simulation, a set of components that are predominantly in an ON state. Any component that experiences voltage or current levels that are close to its maximum rated or breakdown level is considered as a stressed component. Thus a capacitor that has sufficient charge so as to trigger dielectric breakdown, a resistor that is conducting unduly high amounts of current, a reverse-biased diode that is experiencing breakdown, an insulating film that is close to breakdown are all examples of stressed components. By identifying the set of components as stressed components, degradation contribution from components working in best performing mode may be removed from the EOL model, allowing efficient and accurate aging analysis.

At step 210, the set of operating parameters of the identified high stress components are replaced by an aging model to obtain the set of degraded operating parameters for the identified high-stress components.

At step 215, an aged netlist is prepared for the degraded operating parameters. Subsequently, a robustness analysis is performed for the aged netlist.

The method of fast and efficient asymmetric aging analysis is ideal for complex digital circuits and is flexible as it allows asymmetric aging analysis at a user defined time.

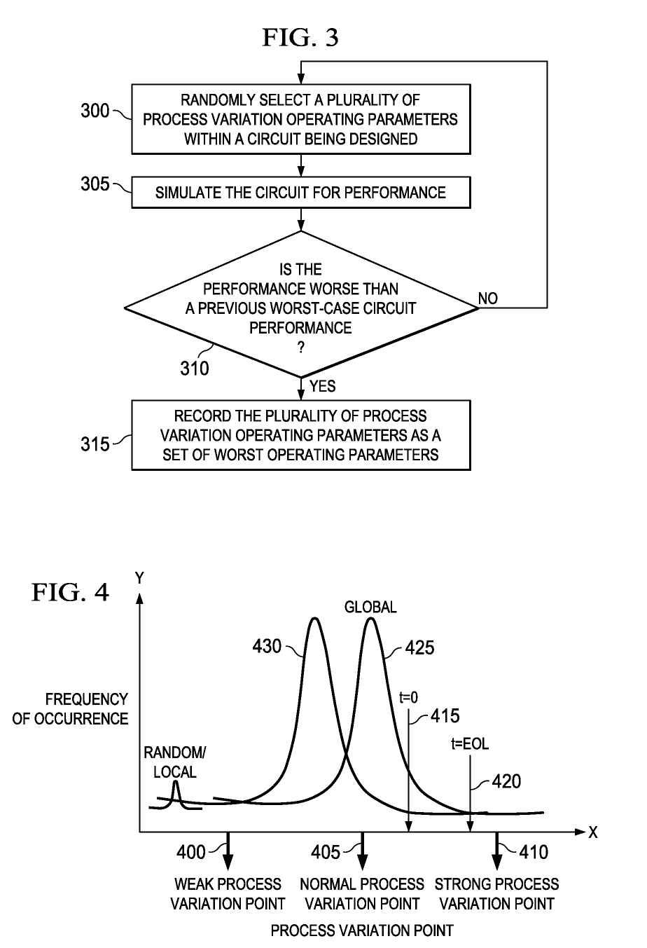

FIG. 3 is a flow chart illustrating a obtaining of worst-case circuit performance for statistical process variation, in accordance with an embodiment.

At step 300, plurality of process variation operating parameters within the circuit being designed are randomly selected. In an embodiment, a group of operating parameters for circuit components are selected at various process points. For example, a worst process point, a nominal process point and a best process point. In some embodiments, the various process points can refer to any process point between the worst process point and the best process point.

At step 305, the circuit is simulated for performance. In an embodiment, an operation of the circuit is simulated to obtain the performance of the circuit.

At step 310, it is determined whether the performance is worse than a previous worst-case circuit performance. If the performance of the circuit is worse than a previous worst-case circuit performance then step 315 is performed else a plurality of process variation operating parameters within the circuit are again randomly selected till the performance of the circuit is worse than a previous worst-case circuit performance.

At step 315, the plurality of process variation operating parameters is recorded as a set of worst operating parameters. Using the set of worst operating parameters, a worst performance for the circuit is determined.

In some embodiment, the method illustrated in FIG. 3 is repeated for a pre-defined number of times till a certain combination of weak-nominal-strong variation points will emerge that result in the worst performance of the circuit.

FIG. 4 shows an exemplary graphical representation for analyzing the worst process variation point with a statistical process. X-axis represents the process variation point and Y-axis represents the frequency of occurrence of the process variation point for a circuit. A plurality of process variation points are shown, for example a weak process variation point 400, a normal process variation point 405, and a strong process variation point 410 are shown. For age analysis, a user can select any of the process variation points with the statistical process. Thus the circuit can be simulated at any arbitrary point or at any user defined time including t=0 (415) and t=EOL (420) thereby enabling to determine which of the corners of the plurality of process variation operating parameters contributes most to the overall worst-case expected circuit performance.

Statistical simulation program with integrated circuit emphasis (SPICE) and Monte Carlo simulation are done that determine a global variation 425 and a random/local variation 430 for the circuit to determine the worst process variation point. The method treats global variation 425 and random or local variation 430 differently in the statistical process since the range of the global variation 425 can be controlled while the range of the random or local variation 430 generally cannot be controlled. The worst process variation point, found in the tail of the performance distribution, represents a combination of operating parameters that result in an extreme behavior of the circuit.

Embodiments of the present disclosure provide for coherent analysis of asymmetric aging and statistical process variation, and efficient asymmetric aging analysis method for complex circuits using the process variation operating parameters that is configured to improve estimates of transistor degradation in the IC.

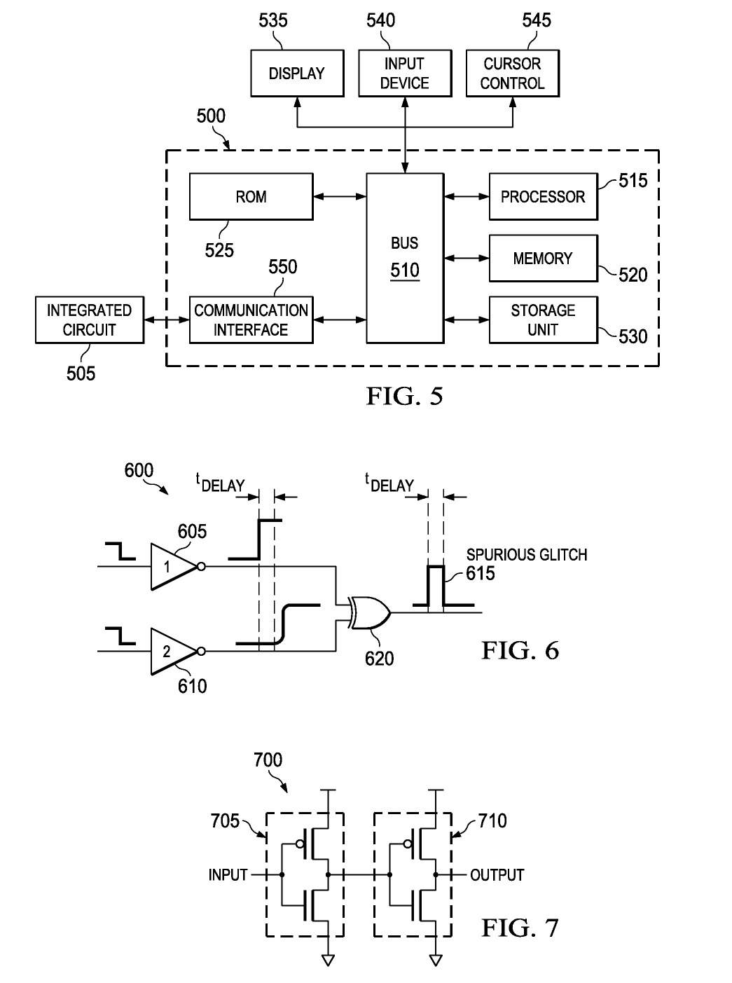

FIG. 5 is a block diagram of a system for designing a circuit, in accordance with which various embodiments can be implemented. The system 500 evaluates an integrated circuit (IC) 505 for asymmetric aging and statistical process variation. Example of the integrated circuit 500 includes, but is not limited to a memory compiler, a SERDES circuit and a core cell.

The system 500 includes a bus 510 or other communication mechanism for enabling electronic communication among various elements of the simulation system 500. The system 500 further includes a processor 515 coupled with the bus 510 for processing information. In some embodiments, the processor 515 can include one or more processing units for performing one or more functions of the processor 515. A processor is a hardware circuit that performs the actual processing of data. The data can be obtained via the bus 510. Here, the data can correspond to netlist, operating parameters and variation points.

In one embodiment, the steps of the present disclosure are performed by the system 500 using the processor 515. The system 500 also includes a memory 520, such as a random access memory (RAM) or other dynamic storage device connected to the bus 510 for storing information required by the processor 515. The memory 520 can also be used for storing temporary information or other intermediate information required by the processor 515. The system 500 further includes a static storage unit such as a read only memory (ROM) 525 coupled to the bus 510 for storing static information required by the processor 515. A storage unit 530, for example a magnetic disk, hard disk or optical disk, can be provided and coupled to bus 510 for storing information.

The processor 515 is responsive to the plurality of instructions to prepare the initial netlist of components in the IC 505, prepare a process variation netlist by using a statistical process to select a plurality of components from the initial netlist, and replace initial operating parameters of selected components with process variation operating parameters. The processor is also operable to identify the plurality of high stress components in the process variation netlist, prepare the aged netlist by replacing the set of operating parameters of the plurality of high stress components with the set of degraded operating parameters, simulate the IC 505 using the aged netlist, and modify the initial netlist according to a result of the simulate and repeat the above operations until a desired circuit performance is obtained.

Further, the processor 515 is operable to simulate operation of the IC 505 using a fast direct current (DC) simulation with an assumed pre-defined static input signal, identify any high stress components that are predominantly in the ON state, replace the set of operating parameters of identified high stress components by an aging model to obtain the set of degraded operating parameters of the identified high-stress components, and prepare the aged netlist for the degraded operating parameters for subsequent robustness analysis.

The system 500 can be coupled via the bus 510 to a display 535, such as a cathode ray tube (CRT), for displaying information to the user. An input device 540, including alphanumeric and other keys, is coupled to the bus 510 for communicating information and command selections to the processor 515. Another type of user input device is a cursor control 545, such as a mouse, a trackball, or cursor direction keys for communicating direction information and command selections to the processor 510 and for controlling cursor movement on the display 535. The functioning of the input device 540 can also be performed using the display 535, for example a touch screen.

The system 500 can be coupled to the IC 505 using a communication interface 550. In some embodiments, plurality of ICs can be coupled to the system 500 using a communication interface 550.

The communication interface 550 provides a two-way data communication and couples the system 500 to the IC 505. For example, the communication interface 550 can be an integrated services digital network (ISDN) card or a modem to provide a data communication connection to a corresponding type of telephone line. As another example, the communication interface 550 can be a local area network (LAN) card to provide a data communication connection to a compatible LAN. Wireless links can also be implemented. The communication interface 550 can also be a Bluetooth port, infrared port, Zigbee port, universal serial bus port or a combination. In any such implementation, the communication interface 550 sends and receives electrical, electromagnetic or optical signals that carry digital data streams representing various types of information.

The system 500 is applicable to evaluate various ICs that include elements such as resistors, capacitors and inductors.

Various embodiments are related to the use of system 500 for implementing the techniques described herein, for example in FIG. 1 through FIG. 3. The techniques can be performed by the system 105 in response to the processor 515 executing instructions included in the memory 520. Execution of the instructions included in the memory 520 causes the processor 515 to perform the techniques described herein.

The term “machine-readable medium” as used herein refers to any medium that participates in providing data that causes a machine to operate in a specific fashion. In an embodiment implemented using the system 500, various machine-readable media are involved, for example, in providing instructions to the processor 515 for execution. The machine-readable medium can be a storage medium. Storage media include both non-volatile media and volatile media. Non-volatile media include, for example, optical or magnetic disks, for example the storage unit 530. Volatile media include dynamic memory, such as the memory 520. All such media must be tangible to enable the instructions carried by the media to be detected by a physical mechanism that reads the instructions into a machine.

Common forms of machine-readable medium include, for example, a floppy disk, a flexible disk, a hard disk, a magnetic tape, any other magnetic medium, a CD-ROM, any other optical medium, punchcards, papertape, any other physical medium with patterns of holes, a PROM, and EPROM, a FLASH-EPROM, any other memory chip or cartridge.

In some embodiments, the machine-readable medium can be transmission media including coaxial cables, copper wire and fiber optics, including the wires that include the bus 510. Transmission media can also take the form of acoustic or light waves, such as those generated during radio-wave and infra-red data communications. Examples of machine-readable medium may include but are not limited to carrier waves as describer hereinafter or any other media from which the system 500 can read, for example online software, download links, installation links, and online links. For example, the instructions can initially be carried on a magnetic disk of a remote computer. The remote computer can load the instructions into its dynamic memory and send the instructions over a telephone line using a modem. A modem local to the system 500 can receive the data on the telephone line and use an infra-red transmitter to convert the data to an infra-red signal. An infra-red detector can receive the data carried in the infra-red signal and appropriate circuitry can place the data on the bus 510. The bus 510 carries the data to the memory 520, from which the processor 515 retrieves and executes the instructions. The instructions received by the memory 520 can optionally be stored on storage unit 530 either before or after execution by the processor 515. All such media must be tangible to enable the instructions carried by the media to be detected by a physical mechanism that reads the instructions into a machine.

FIG. 6 and FIG. 7 illustrate how a circuit may be tested so as to isolate the effect of process variation and asymmetric aging due to negative biased temperature instability (NBTI) degradation.

FIG. 6 shows an example XOR network 600 being fed by a first inverter 605 and a second inverter 610 in which the coherent analysis of asymmetric aging and statistical process variation of the present disclosure can be implemented. If both the first inverter 605 and the second inverter 610 are matched for the same characteristics, then a 1→0 transition as inputs to the first inverter 605 and the second inverter 610 would not result in a spurious glitch 615 as t_{delay} at an XOR gate 620 output. However, if the first inverter 605 has a superior rise time and the second inverter 610 has a poor rise time, then the spurious glitch 615 would occur at the XOR gate 620 output. The resulting output characteristics represent circuit degradation from process variations.

An example circuit of two CMOS inverters that includes a buffer 700 is provided in FIG. 7 for the purpose of illustrating the effect of asymmetric aging. If the input to a first PMOS transistor of the first inverter 705 is a logical 0 and it would be mostly in the ON state without conducting current. A second PMOS transistor of second inverter 710 would however be in OFF state. Therefore the first PMOS transistor of first inverter 705 would age more rapidly than the second PMOS transistor of second inverter 710 due to NBTI degradation. The resulting output characteristics would represent circuit degradation from PMOS NBTI only.

The NBTI causes the threshold voltage Vₜ of a transistor to shift which further causes a shift in the minimum operating voltage Vₘᵢₙ of the circuit. Specifically, the increase in Vₜ that results from NBTI degradation affects the circuit performance. As a result, a higher voltage is required to maintain the same operating performance of the circuit. Due to the Vₜ and Vₘᵢₙ relationship, and common usage of Vₘᵢₙ for product level simulation testing, the NBTI degradation analysis described herein can be used as an indicator of circuit reliability.

The present disclosure describes a technique for analysis on the impact of aging of a circuit due to the worst process variation point and process variation, and redesign of the circuit. The technique can be used by a designer to assess the impact of asymmetric aging. Additionally, the technique can also be extended to degradations like PBTI (positive bias temperature instability), time-dependent dielectric breakdown (TDDB) and aging analysis to metal or poly interconnects, where the interconnects age due to phenomenon like electro-migration.

In the foregoing discussion, each of the terms “coupled” and “connected” refers to either a direct electrical connection or mechanical connection between the devices connected or an indirect connection through intermediary devices.

The foregoing description sets forth numerous specific details to convey a thorough understanding of embodiments of the disclosure. However, it will be apparent to one skilled in the art that embodiments of the disclosure may be practiced without these specific details. Some well-known features are not described in detail in order to avoid obscuring the disclosure. Other variations and embodiments are possible in light of above teachings, and it is thus intended that the scope of disclosure not be limited by this Detailed Description, but only by the Claims.

What is claimed is:

1. A method of designing a circuit, the method comprising:
preparing an initial netlist of components in the circuit;
selecting a plurality of components from the initial netlist by a first statistical process;
preparing a process variation netlist by replacing a plurality of initial operating parameters of the plurality of components with a plurality of process variation operating parameters;
identifying a plurality of high stress components in the process variation netlist;
preparing an aged netlist by replacing a set of operating parameters of the plurality of high stress components with a set of degraded operating parameters;
simulating the circuit using the aged netlist; and
modifying the initial netlist according to a result of the simulating and repeating the foregoing steps until a desired circuit performance is obtained.

2. The method as claimed in claim 1, wherein the first statistical process comprises random selection.

3. The method as claimed in claim 1, wherein the first statistical process comprises one of a histogram statistical analysis and a distribution statistical analysis.

4. The method as claimed in claim 1, wherein the set of initial operating parameters includes one or more of a threshold voltage, a total power dissipation, a junction temperature, an ambient temperature, a drain-source current, a collector emitter saturation voltage, and a base emitter saturation voltage.

5. The method as claimed in claim 1, wherein preparing the aged netlist comprises:
simulating operation of the circuit using a fast direct current (DC) simulation with an assumed pre-defined static input signal;
identifying any high stress components that are predominantly in an ON state;
replacing the set of operating parameters of the identified high stress components by an aging model to obtain the set of degraded operating parameters of the identified high-stress components; and
preparing the aged netlist for the degraded operating parameters for subsequent robustness analysis.

6. The method as claimed in claim 1, wherein identifying the plurality of high stress components comprises:
simulating operation of the circuit using a fast direct current (DC) simulation with an assumed pre-defined static input signal; and
identifying any components that are subjected to a voltage level that is within a predefined interval of a corresponding breakdown level.

7. The method as claimed in claim 1, wherein identifying the plurality of high stress components comprises:
simulating operation of the circuit using a fast direct current (DC) simulation with an assumed pre-defined static input signal; and
identifying any components that are predominantly in an ON state.

8. The method as claimed in claim 1, wherein identifying the plurality of high stress components comprises:
simulating operation of the circuit using a fast direct current (DC) simulation with an assumed pre-defined static input signal; and
identifying any components that are predominantly in an ON state and carry a current having a value less than a predefined value.

9. The method as claimed in claim 1, wherein identifying the plurality of high stress components comprises:
simulating operation of the circuit using a fast direct current (DC) simulation with an assumed pre-defined static input signal; and
identifying any resistive components that carry an electrical current having a magnitude that exceeds a predefined magnitude.

10. The method as claimed in claim 1, wherein identifying the plurality of high stress components comprises:
simulating operation of the circuit using a fast direct current (DC) simulation with an assumed pre-defined static input signal; and
identifying any capacitive components that are subjected to a quantity of electric charge of sufficient magnitude to cause a dielectric breakdown.

11. The method as claimed in claim 1, wherein identifying the plurality of high stress components comprises:
simulating operation of the circuit using a fast direct current (DC) simulation with an assumed pre-defined static input signal; and
identifying any diodes that are biased to within a predefined level of a reverse breakdown voltage.

12. The method as claimed in claim 1, wherein identifying the plurality of high stress components comprises:
simulating operation of the circuit using a fast direct current (DC) simulation with an assumed pre-defined static input signal; and
identifying any components having insulating films that are subjected to a voltage of breakdown level.

13. The method as claimed in claim 1, wherein the modifying comprises:
comparing a new process variation point that results from simulating the circuit with a previous worst-case process variation point, the new process variation point including the plurality of process variation operating parameters;
recording the plurality of process variation operating parameters as a set of worst-case operating parameters if the new process variation point is worse than the previous worst-case process variation point; and
repeating, simulating the circuit if the new worst-case process variation point is not worse than the previous worst-case process variation point.

14. A system for designing a circuit, the system comprising:
a communication interface in electronic communication with one or more electronic circuits;
a memory coupled to the communication interface for storing a plurality of instructions; and
a processor coupled to the communication interface and the memory, and responsive to the plurality of instructions to
prepare an initial netlist of components in the circuit;
prepare a process variation netlist by using a statistical process to select a plurality of components from the initial netlist, and replace initial operating parameters of selected components with process variation operating parameters;
identify plurality of high stress components in the process variation netlist;
prepare an aged netlist by replacing a set of operating parameters of the plurality of high stress components with a set of degraded operating parameters;
simulate the circuit using the aged netlist; and
modify the initial netlist according to a result of the simulate, and repeat the above operations until a desired circuit performance is obtained.

15. The system as claimed in claim 14, wherein the statistical process comprises random selection.

16. The system as claimed in claim 14, wherein the statistical process includes at least one of a histogram statistical analysis and a distribution statistical analysis.

17. The system as claimed in claim 14, wherein the processor is operable to
simulate operation of the circuit using a fast direct current (DC) simulation with an assumed pre-defined static input signal;
identify any high stress components that are predominantly in an ON state;
replace the set of operating parameters of identified high stress components by an aging model to obtain the set of degraded operating parameters of the identified high-stress components; and
prepare the aged netlist for the degraded operating parameters for subsequent robustness analysis.

18. The system as claimed in claim 14, wherein the processor is further operable to:
compare a new process variation point that resulted from simulating the circuit with a previous worst-case process variation point, the new process variation point including the plurality of process variation operating parameters;
record the plurality of process variation operating parameters as a set of worst-case operating parameters if the new process variation point is worse than the previous worst-case process variation point; and
repeat, simulating the circuit if the new worst-case process variation point is not worse than the previous worst-case process variation point.
